(19) United States
(12) Patent Application Publication
(10) Pub. No.: US 2008/0169002 A1
(43) Pub. Date: Jul. 17, 2008

(54) Makeup brush, method and apparatus for manufacturing thereof

(75) Inventor: Jae Kwang Hwang, Seoul (KR)

Correspondence Address: BUCHANAN, INGERSOLL & ROONEY PC, POST OFFICE BOX 1404, ALEXANDRIA, VA, 22313-1404, US

(73) Assignee: F.S. KOREA INDUSTRIES INC., Seoul (KR)

(21) Appl. No.: 11/889,621

(22) Filed: Aug. 15, 2007

(30) Foreign Application Priority Data
Jan. 12, 2007 (KR) 10-2007-0004014
May 28, 2007 (KR) 10-2007-0051699

(51) Int. Cl. A45D 40/26; A46B 9/02; B25G 1/00

(52) U.S. Cl. 132/320; 15/143.1; 15/160

(57) ABSTRACT

Disclosed are a makeup brush, and an apparatus and a method for manufacturing thereof. The makeup brush according to the present invention includes a brush body used as a handle; and a plurality of brushes attached to one side of the brush body, wherein the brushes have markings such as figures, signs and letters, or have partially different physical properties by arranging the brushes with different colors or materials. Therefore, the makeup brush according to the present invention may be useful to realize a variety of shapes for the purpose of the growth of buying power, the image enhancement or public relations of the makeup products, and to have partially modify physical properties such as elasticity, flexibility and the sense of touch, if necessary, by arranging a plurality of brushes having different color and materials in the brush body.

### TECHNICAL FIELD

The present invention relates to a makeup brush, and a method and an apparatus for manufacturing thereof, and more particularly to a makeup brush capable of realizing various shapes and having partially different physical properties by arranging a plurality of brushes having different colors or materials, and a method and an apparatus for manufacturing thereof.

### BACKGROUND ART

Generally, brushes used for makeup have been widely used as a tool for applying cosmetics to a user's face, etc., and these makeup brushes are manufactured in a variety of the shapes and the sizes according to their uses. Generally, small brushes are used for application of eye shadow, etc., whereas big brushes are used for chic touch and application of powder to a user's face.

These conventional makeup brushes are manufactured by inserting brushes into a handle using an insertion apparatus, and fixing the brushes using a pressure process or an adhesive, wherein the handle is made of synthetic resin, woods or the like.

However, the conventional makeup brushes have obstacles to growth of buying power, image enhancement or public relations of makeup products since brushes themselves are made of materials having a single color or a single material, and may not partially modify physical properties such as elasticity, flexibility and the sense of touch, if necessary. Also, the conventional makeup brushes have any difficulty in being manufactured for the purpose of solving the above problems.

### DISCLOSURE

### Technical Problem

Accordingly, the present invention has been made to solve the above-mentioned problems in the prior art, and an object of the present invention is to provide a makeup brush capable of realizing various shapes for the purpose of growth of buying power, image enhancement or public relations of makeup products and having partially different physical properties such as elasticity, flexibility and the sense of touch, if necessary, by arranging a plurality of brushes having different colors or materials, and a method and an apparatus for manufacturing thereof.

### Technical Solution

In accordance with one embodiment of the present invention, there is provided a makeup brush including a brush body used as a handle; and a plurality of brushes attached to one side of the brush body, wherein the brushes have markings such as figures, signs and letters, or have partially different physical properties by arranging the brushes with different colors or materials.

Also, there is provided a method for manufacturing a makeup brush in which a plurality of brushes having different colors or materials are arranged in a brush body, the method including steps of installing an outer ring in one side of the brush body; mounting a space compartment member for compartmentalizing a space in which the respective brushes are inserted into the outer ring; arranging the brushes to have markings such as figures, signs and letters or have partially different physical properties by inserting the respective brushes into all the spaces and fixing the brushes, wherein the spaces are compartmentalize by the space compartment member in the inner side of the outer ring, and wherein the brushes have different colors or materials; and removing the outer ring and the space compartment member from the brush body.

Also, there is provided an apparatus for manufacturing a makeup brush in which a plurality of brushes having different colors or materials are arranged in a brush body, the apparatus including an outer ring inserted into the brush body; and a space compartment member for compartmentalizing a space, the member being mounted in the inner side of the outer ring to insert the respective brushes.

### BRIEF DESCRIPTION OF THE DRAWINGS

The foregoing and other objects, features and advantages of the present invention will become more apparent from the following detailed description when taken in conjunction with the accompanying drawings.

FIG. 1 is a perspective view showing a makeup brush according to the first embodiment of the present invention.

FIG. 2 is a perspective view showing a makeup brush according to the second embodiment of the present invention.

FIG. 3 is a flowchart illustrating a method for manufacturing a makeup brush according to the present invention.

FIG. 4 is an exploded perspective view showing an apparatus for manufacturing a makeup brush according to the present invention.

FIG. 5 is a plane view showing an apparatus for manufacturing a makeup brush according to the present invention.

### DESCRIPTIONS OF MAJOR PARTS IN THE DRAWINGS

10, 30: makeup brush
11, 31: brush body
12, 32, 33, 34: brush (synthetic fiber)
13: brush (natural hair)
20: exterior brush manufacturing apparatus
21: outer ring
22: space compartment member
23, 24: compartment element
25: connection element
26: fixation element

### BEST MODE

Hereinafter, preferred embodiments of the present invention will be described with reference to the accompanying drawings, so that the present invention may be easily put into practice by those skilled in the art.

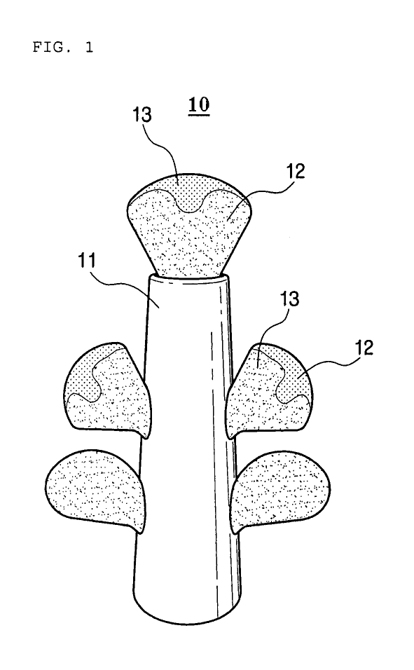

FIG. 1 is a perspective view showing a makeup brush according to the first embodiment of the present invention. As shown in FIG. 1, the makeup brush 10 according to the first embodiment of the present invention includes a brush body 11; and a plurality of brushes 12, 13 arranged in one side of the brush body 11.

The brush body 11 is made of a synthetic resin, woods or the like, and used as a handle. At this time, an opening/closing space may be formed inside the brush body 11, if necessary, the opening/closing space being used for storing cosmetics, etc., and the brushes 12, 13 may be provided in various positions of the brush body 11, for example one end of the brush body 11, as well as the other end or sides of the brush body 11. In this embodiment, a plurality of the brushes 12, 13 arranged to have different colors or materials are provided in the top and sides of the brush body 11.

The respective brushes 12, 13 are arranged and connected to one side of the brush body 11, wherein the respective brushes 12, 13 have different colors or materials. Accordingly, the brushes 12, 13 have markings such as figures, signs and letters, for example flowers, characters, promotional letters, trade marks, etc, or have partially different physical properties, for example elasticity, flexibility, the sense of touch, etc., by arranging the brushes 12, 13, which have different colors or are made of different materials, in a suitable position.

Meanwhile, a plurality of the brushes 12, 13 may be composed of a synthetic fiber 12 and a natural hair 13. In this case, the natural hair 13 may be preferably arranged in a central region of the brush body 11, and the synthetic fiber 12 may also be preferably arranged around the natural hair 13. Accordingly, the powder is easily applied to the skin by the natural hair 13 arranged in a central region of the brush body 11, and the natural hair 13 is maintained in certain arrangement forms by maintaining an elastic force of the natural hair 13 through the synthetic fiber 12 arranged around the natural hair 13.

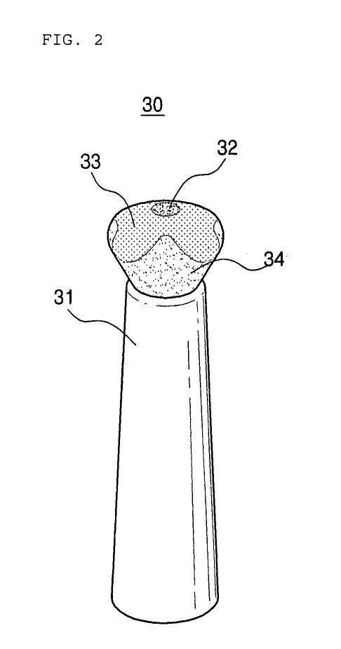

FIG. 2 is a perspective view showing a makeup brush according to the second embodiment of the present invention. As shown in FIG. 2, the makeup brush 30 according to the second embodiment includes a brush body 31; and a plurality of brushes 32, 33, 34 arranged in one side of the brush body 31, like the first embodiment. However, the makeup brush 30 according to this embodiment is made of a synthetic fiber having different colors, unlike the first embodiment, wherein the synthetic fiber is composed of a plurality of brushes 32, 33, 34 which are arranged in the top of the brush body 31 to have markings such as figures, signs and letters, wherein the brushes 32, 33, 34 is made of a synthetic fiber having different colors, unlike the first embodiment.

As described above, the respective brushes 32, 33, 34 may display a variety of colors since the synthetic fiber is easily colored in the manufacturing process of the synthetic fiber, and therefore it is possible to easily obtain the brushes 32, 33, 34 having the desired colors and shapes.

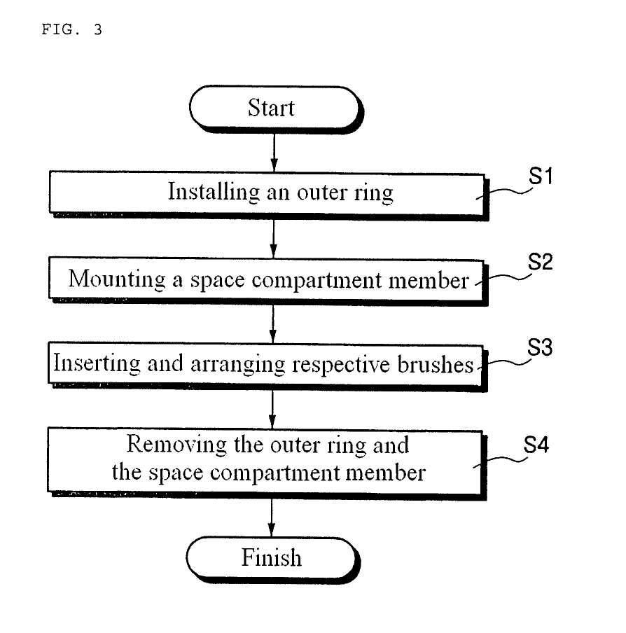

FIG. 3 is a flowchart illustrating a method for manufacturing a makeup brush according to the present invention. In order to arrange a plurality of brushes 12, 13, 32, 33, 34 (see FIG. 1 and FIG. 2) with different colors or materials in brush bodies 11, 31 (see FIG. 1 and FIG. 2), the method for manufacturing a makeup brush according to the present invention includes steps of installing an outer ring (S1); mounting a space compartment member (S2); inserting and arranging the respective brushes (S3); and removing the outer ring and the space compartment member (S4), as shown in FIG. 3.

In the outer ring installation step (S1), an outer ring is installed in a brush mounting portion formed in the brush bodies 11, 31 used as a handle, wherein the outer ring has a ring shape such as circle, polygons or the like.

In the space compartment member mounting step (S2), a space compartment member for compartmentalizing the inside of an outer ring into a plurality of spaces is inserted and mounted into the outer ring.

In the respective brush insertion and arrangement step (S3), the brushes 12, 13, 32, 33, 34 are arranged to have markings such as figures, signs and letters, for example flowers, characters, promotional letters, trade marks, etc., or to have partially different physical properties, for example elasticity, flexibility, the sense of touch, etc., by inserting the respective brushes 12, 13, 32, 33, 34 (see FIG. 1 and FIG. 2) into all spaces using an insertion apparatus, etc., and fixing the respective brushes 12, 13, 32, 33, 34, wherein the spaces are compartmentalized by the space compartment member arranged inside the outer ring, and the brushes 12, 13, 32, 33, 34 have different color and materials.

Meanwhile, the respective brushes used in the brush insertion and arrangement step (S3) are preferably made of the synthetic fiber 12 and the natural hair 13 as shown in FIG. 1, or preferably made of the synthetic fiber 32, 33, 34 having different colors as shown in FIG. 2.

In the outer ring and space compartment member removal step (S4), the outer ring and the space compartment member, which are used for the insertion of the respective brushes 12, 13, 32, 33, 34, are removed off when the brushes 12, 13, 32, 33, 34 are fixed in the brush bodies 11, 31. Therefore, the manufacture of the makeup brushes 10, 30 as shown in FIG. 1 and FIG. 2 is completed.

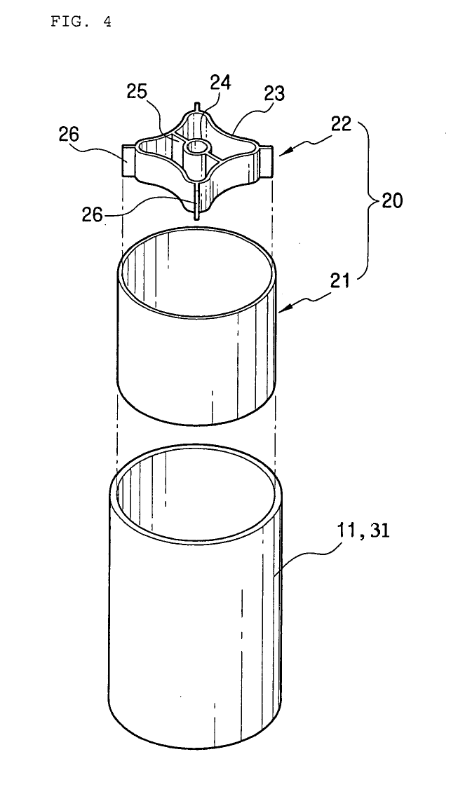

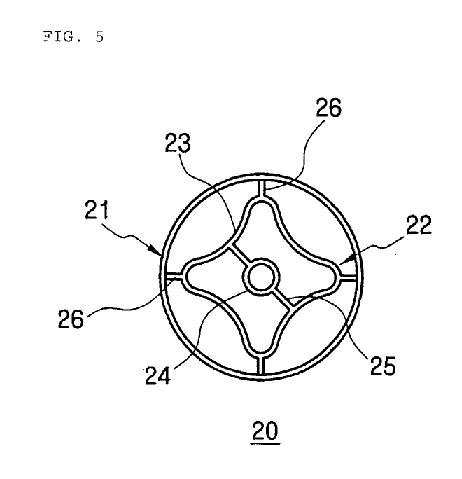

FIG. 4 and FIG. 5 are an exploded perspective view and a plane view showing an apparatus for manufacturing a makeup brush according to the present invention, respectively. The apparatus 20 used in the method for manufacturing a makeup brush according to the present invention, which is an apparatus that is used to arrange a plurality of the brushes 12, 13, 32, 33, 34 (see FIG. 1 and FIG. 2) having different color and materials in the brush bodies 11, 31, includes an outer ring 21; and a space compartment member 22 mounted inside the outer ring 21.

The outer ring 21, which has a ring shape such as circle, polygons or the like, is inserted and fixed into a brush mounting portion of the brush bodies 11, 31, thereby to render the entire appearance of the brushes 12, 13, 32, 33, 34.

The space compartment member 22 is mounted inside the outer ring 21 to compartmentalize a space into a plurality of compartments into which the respective brushes 12, 13, 32, 33, 34 are inserted.

The space compartment member 22 includes compartment elements 23, 24 arranged inside the outer ring 21 to have sectional markings such as figures, signs and letters, for example flowers, characters, promotional letters, trade marks, etc.; and fixation elements 26 formed in the outer ring 21 or the compartment element 23 to fix the compartment elements 23, 24 in the inner side of the outer ring 21.

In this embodiment, the compartment element 23 is installed inside the outer ring 21 by integrally forming the fixation elements 26 in a circumferential surface of the compartment element 23 to support a circumferential surface of the outer ring 21.

The compartment elements 23, 24 are formed in large numbers so that they can be arranged inwardly/outwardly to increase the number of the spaces into which the respective brushes 12, 13, 32, 33, 34 (see FIG. 1 and FIG. 2) are inserted and fixed, and the compartment elements 23, 24 are connected to each other by the connection element 25 to maintain a predetermined shape in the outer ling 21.

Meanwhile, the outer ring 21 and the space compartment member 22 may be manufactured into desired shapes using a mold, or manufactured by cutting, bending, or welding an iron plate, etc. At this time, the outer ring 21 and the space compartment member 22 have a thickness range without intercepting the insertion of the brushes 12, 13, 32, 33, 34, for example a thickness of 0.3-1.0 mm, and preferably 0.5 mm.

As described above, the makeup brush according to the preferred embodiment of the present invention may be useful to realize a variety of shapes for the purpose of the growth of buying power, the image enhancement or public relations of the makeup products, and to partially modify physical properties such as elasticity, flexibility and the sense of touch, if necessary, by arranging a plurality of brushes 12, 13, 32, 33, 34 (see FIG. 1 and FIG. 2) having different color and materials in one side of the brush body.

### INDUSTRIAL AVAILABILITY

As described above, the makeup brush according to the present invention and the method and apparatus for manufacturing thereof have advantageous effects to realize a variety of shapes for the purpose of the growth of buying power, the image enhancement or public relations of the makeup products, and to partially modify physical properties such as elasticity, flexibility and the sense of touch, if necessary, by arranging a plurality of brushes having different color and materials in one side of the brush body.

As described above, the preferred embodiments of the present invention have been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description, as defined in the appended claims.

1. A makeup brush, comprising:
a brush body used as a handle; and
a plurality of brushes attached to one side of the brush body, wherein the brushes have markings such as figures, signs and letters, or have partially different physical properties by arranging the brushes with different colors or materials.

2. The makeup brush according to claim 1, wherein a plurality of the brushes are made of synthetic fiber and natural hair.

3. The makeup brush according to claim 2, wherein a plurality of the brushes are made of synthetic fiber and natural hair so that the natural hair is arranged in a central region of the brushes and the synthetic fiber is arranged in a peripheral region of the brushes.

4. The makeup brush according to claim 1, wherein a plurality of the brushes are synthetic fiber having different colors.

5. A method for manufacturing a makeup brush in which a plurality of brushes having different colors or materials are arranged in a brush body, the method comprising:
installing an outer ring in one side of the brush body;
mounting a space compartment member for compartmentalizing a space in which the respective brushes are inserted into the outer ring;
arranging the brushes to have markings such as figures, signs and letters or have partially different physical properties by inserting the respective brushes into all the spaces and fixing the brushes, wherein the spaces are compartmentalize by the space compartment member in the inner side of the outer ring, and wherein the brushes have different colors or materials; and
removing the outer ring and the space compartment member from the brush body.

6. The method according to claim 5, wherein, in the brush insertion and arrangement steps, the respective brushes are made of a synthetic fiber and a natural hair.

7. The method according to claim 5, wherein, in the brush insertion step, the respective brushes are made of a synthetic fiber having different colors.

8. An apparatus for manufacturing a makeup brush in which a plurality of brushes having different colors or materials are arranged in a brush body, the apparatus comprising:
an outer ring inserted into the brush body; and
a space compartment member for compartmentalizing a space, the member being mounted in the inner side of the outer ring to insert the respective brushes.

9. The apparatus according to claim 8, wherein the space compartment member includes:
compartment elements which are arranged inside the outer ring and whose sections have markings such as figures, signs and letters; and
fixation elements formed in the outer ring or the compartment elements to fix the compartment elements in the inner side of the outer ring.

10. The apparatus according to claim 9, wherein the compartment elements are arranged inwardly/outwardly in large numbers, and connected by the connection element.
